(19) United States
(12) Patent Application Publication
(10) Pub. No.: US 2019/0100055 A1
(43) Pub. Date: Apr. 4, 2019

(54) FOAM FILLED CAR WHEEL AND ITS MANUFACTURING METHOD

(71) Applicant: Ting-Wei Chang, New Taipei City (TW)

(72) Inventor: Ting-Wei Chang, New Taipei City (TW)

(21) Appl. No.: 15/723,178

(22) Filed: Oct. 3, 2017

(51) Int. Cl. B60C 7/10; B60B 3/10; B29D 30/02

(52) U.S. Cl. CPC B60C 7/105; B60B 3/10; B29K 2105/04; B60B 2360/102; B29D 30/02

(57) ABSTRACT

A foam filled wheel and its manufacturing method, wherein it comprises: a steel ring, connecting a power device of the car, wherein the steel ring has a filling mouth; a tire set outside around the steel ring; and filling materials, disposed between the steel ring and the tire through the filling mouth; it is characterized in that: the filling materials are foaming materials, thereby the tire will not leak, thence it is achieved that the tire can support the car steadily in case of damage.

### FIELD OF THE INVENTION

The present invention relates to a foam filled car wheel and its manufacturing method, particularly to a car wheel and its manufacturing method, wherein foam materials are used as filling materials between a steel ring and a tire through a filling mouth, thence the tire cannot leak and the tire can support a car steadily even in case of damage.

### BACKGROUND OF THE INVENTION

These days cars take much convenience, especially for transport in the street. The conventional air-filled wheel is constructed of steel ring, tire and filling air for resilient support to reduce quake caused by irregular pavement.

However, damaged tire, even just with a tiny hole pierced, cannot support the car any more. As result, repair or replace of damaged tire make problem.

Besides, during driving damaged tire can cause traffic accidents. Seriously, life of driver and passersby are threatened cause of puncture. According to the World Traffic Safety Commission, traffic accidents caused of damaged tires accounts to 27%, serious traffic accidents caused of puncture accounts to 67%. This shows the importance of tires for traffic safety.

Furthermore, even tires are airproof, however, in most cases tire pressure reduces 1 psi each month. Therefore, in standard operating manual a car owner is required, to check fullness of the tire and to measure tire pressure at least e in month, it is inconvenient.

Besides, it is well known, that the effect of air thermal expansion and contraction is very obvious. Since a tire has a certain volume, change of tire temperature is vast during cold state and high speed driving, Therefore, change of tire pressure is vast. As result, life of a tire reduces.

Moreover, normally thread pattern after certain wear and tear, change of a tire is required. For saving money there is recycling tire developed, wherein for saving money new tread pattern is jointed on the tire, after tread pattern is flattened. However, after long-term use, damage is accumulated in the inner tire, even outworn tread pattern is invisible. As a matter of fact, recycled tire is not safe.

In view of these disadvantages the inventor tried the continuous testing and improvement and developed the present invention.

### SUMMARY OF THE INVENTION

The main object of the present invention is to provide a foam filled car wheel and its manufacturing method, wherein the tire will not leak and the tire can support the car steadily even in case of damage.

For achieving above object, the present invention comprises: a steel ring, connecting a power device of a car, having a filling mouth inside the steel ring; a tire, set outside around the steel ring; and filling materials, injected between the steel ring and the tire through the filling mouth of the steel ring; it is characterized in that: the filling materials are foam materials, whereby a tire will not leak, thence it is achieved that the tire can support the car steadily even in case of damage.

Another object of the present invention is to provide a foam filled car wheel and its manufacturing method, wherein the tire pressure is kept stable, and life of tire is extended.

For achieving above object, it is characterized in that: filling materials of the tire are foaming materials, which cannot leak and is free from hot up and down due to temperature change. Thence, it is achieved, that tire pressure is kept stable, and life of tire is extended.

Another object of the present invention is to provide a foam filled car wheel and its manufacturing method, wherein tires can be changed easily.

For achieving above object, it is characterized in that: outside around the steel ring is coated with release agent, whereby the foamed filling materials in the inner tire cannot stick the steel ring. Thence it is achieved, that tires can be changed easily.

Another object of the present invention is to provide a foam filled car wheel and its manufacturing method, wherein it is avoided, the changed tire to be remanufactured as recycling tires.

For achieving above object, it is characterized in that: after the tire is set on the steel ring and filled with foaming materials, tire pressure cannot reduce by removing the filling materials, Thence, it is achieved that remanufacturing a recycling tire is avoided.

Another object of the present invention is to provide a foam filled car wheel and its manufacturing method, wherein gas of conventional air filled car wheel is replaced by filling materials of foaming materials, whereby, disadvantages of leaking and puncture of a conventional air filled car wheel are avoided and safety is increased.

For achieving above object, it is characterized in that: using steel ring and tire of a conventional car wheel; replace gas of conventional air filled car wheel by filling materials of foaming materials, whereby disadvantages of leaking and puncture of a conventional gas filled car wheel are removed, thence it is achieved that safety is increased.

Other aspects and advantages of the present invention will become apparent from the following detailed description, taken in conjunction with the accompanying drawing, illustrating by way of example the principles of the present invention.

### BRIEF DESCRIPTION OF THE DRAWING

FIG. 1 is a perspective view of the present invention,

FIG. 2 is the flow chart of the manufacturing method of the present invention.

FIG. 3 is a sectional view of the present invention.

FIG. 3A shows outside around the steel ring coated with release agent.

FIG. 4 shows the filling materials disposed between a steel ring and a tire.

FIG. 5 shows the filling material of the present invention flowing in the bottom of the tire.

FIG. 6 shows, gas removed from the filling mouth of the steel ring during the foaming process of the filling materials in the present invention.

FIG. 6A shows filling materials covering the filling mouth of the steel ring, during foaming process of the filling materials in the present invention.

FIG. 7 shows the filling materials of the present invention filled between a steel ring and a tire after finishing the foaming process.

### DESCRIPTION OF THE PREFERRED EMBODIMENTS

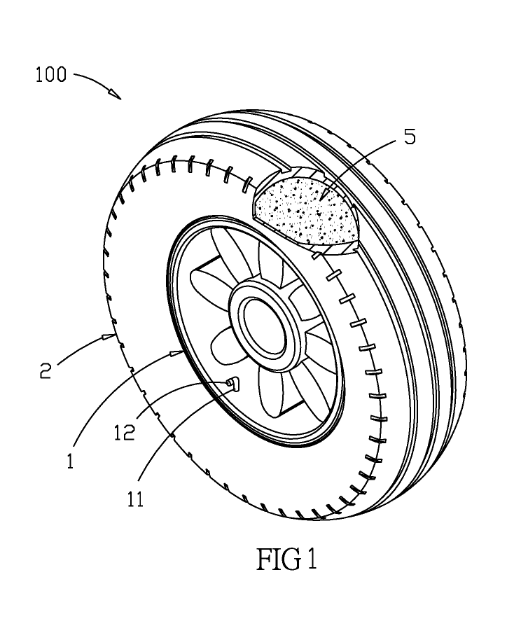

as shown in FIG. 1, a foam filled wheel of the present invention 100 comprises: a steel ring 1, connecting a power device of a car (not shown) and having a filling mouth 11 with a filling mouth check valve 12 inside; a tire 2, set outside around the steel ring 1; and filling materials 5 disposed between the steel ring 1 and the tire 2 through the filling mouth 11 of the steel ring 1; it is characterized in that: the filling materials 5 are foaming materials, disposed between the steel ring 1 and the tire 2 through the filling mouth 11 of the steel ring 1. Thereby, the tire will not leak, thence it is achieved that the tire can support the car steadily even in case of damage.

In the present invention conventional steel ring and tire are used, wherein conventional filling gas is replaced by foaming materials, injected into the tire 2; whereby disadvantages of leaking, puncture in conventional air filled car wheel are avoided. Thence it is achieved that safety is increased.

Therein, the tire has an inner tire body (not shown) and the filling materials 5 are filled in the said inner tire body.

Filling materials 5 are foaming polymer materials of low specific gravity, which after solidification become a resilient solid, and comprise: 5˜18 weight % of foaming agents (like HFC-245; 1.1.1.3.3-pentafluoropropane, 9˜25 weight % of antioxidants (likeBHT), 30˜60 weight of foam stabilizers (like Tegostab B8462) and 20˜25 weight % of catalysts (like Dabco TMR-4). Since filling materials 5 in the tire 2 are foaming materials, the tire will not leak, thence it is achieved that the tire can support the car steadily even in case of damage.

Besides, since filling materials 5 in the tire 2 are foaming materials, so the tire cannot leak, is free from hot up and down due to temperature change. Thence, tire pressure is kept stable, and it is achieved, that life of a tire is extended.

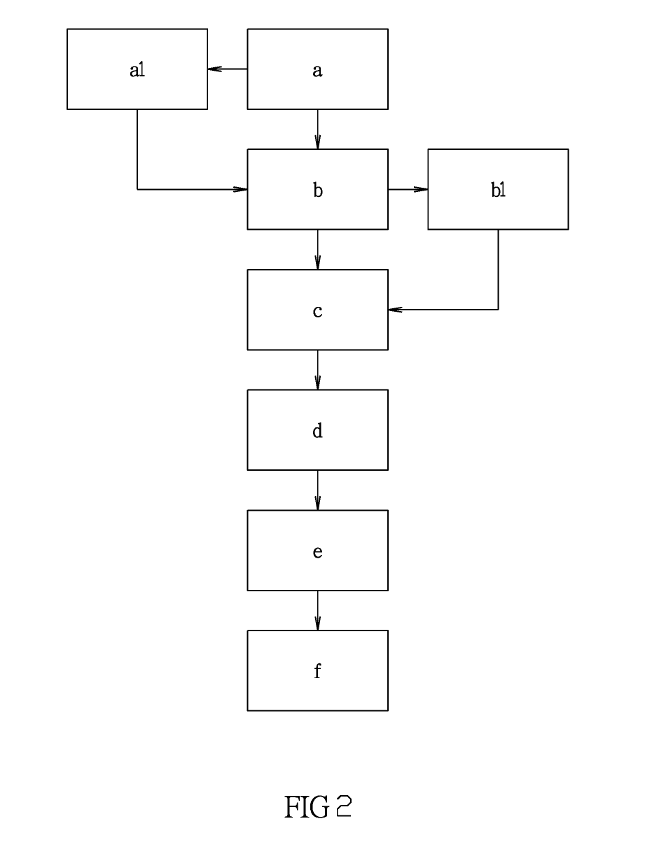

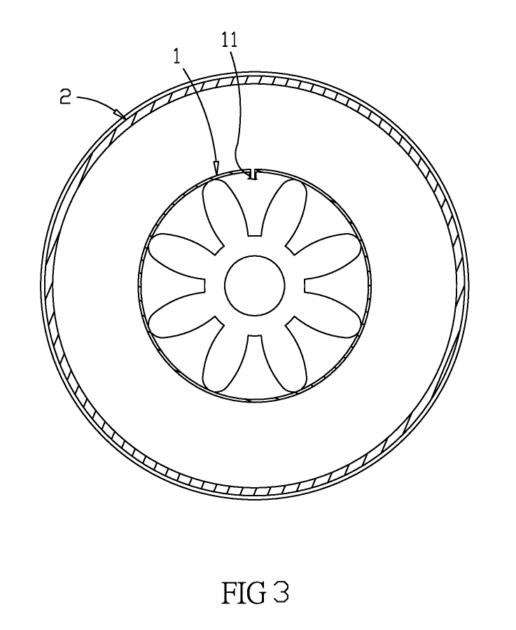

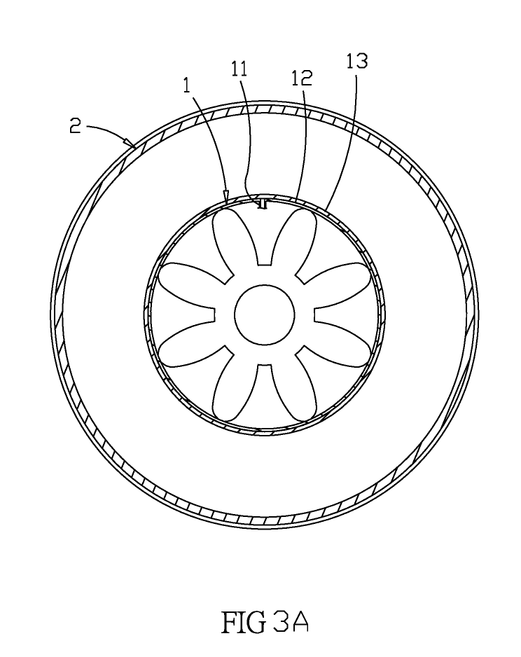

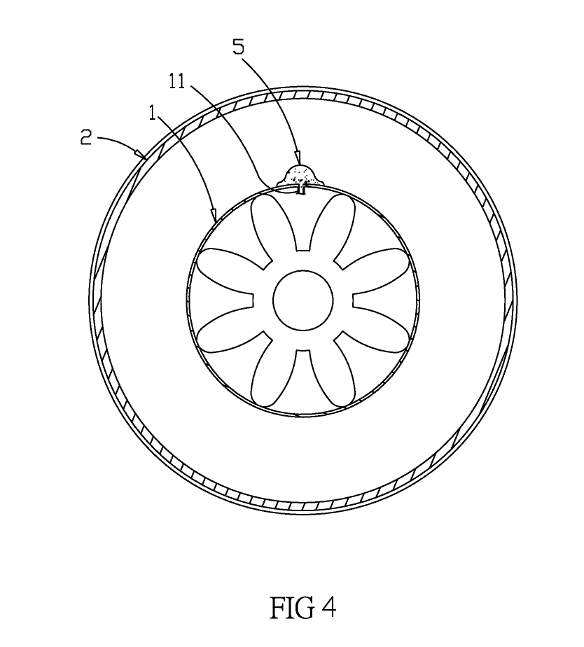

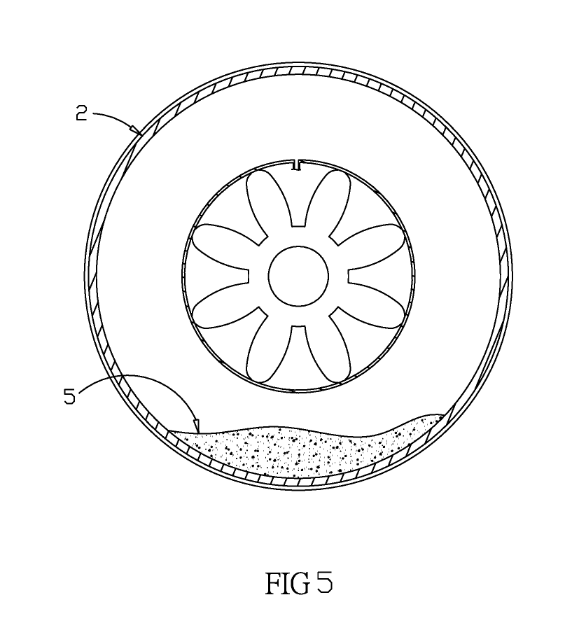

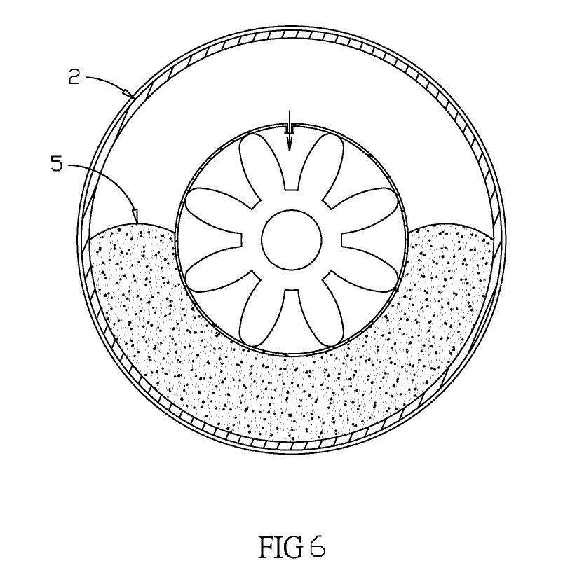

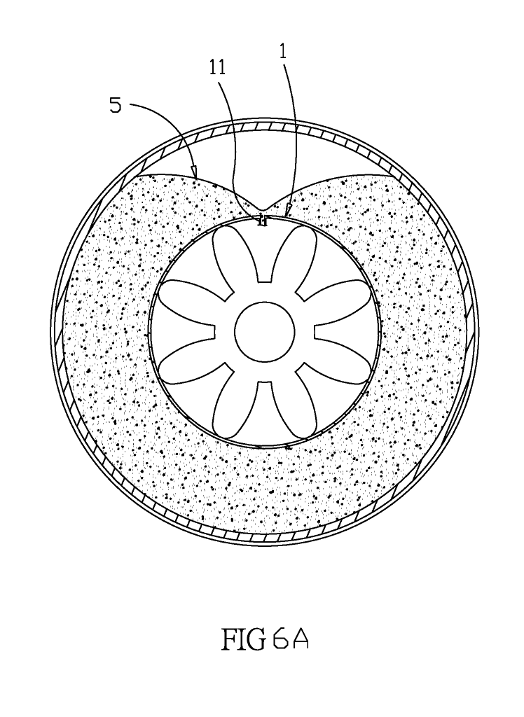

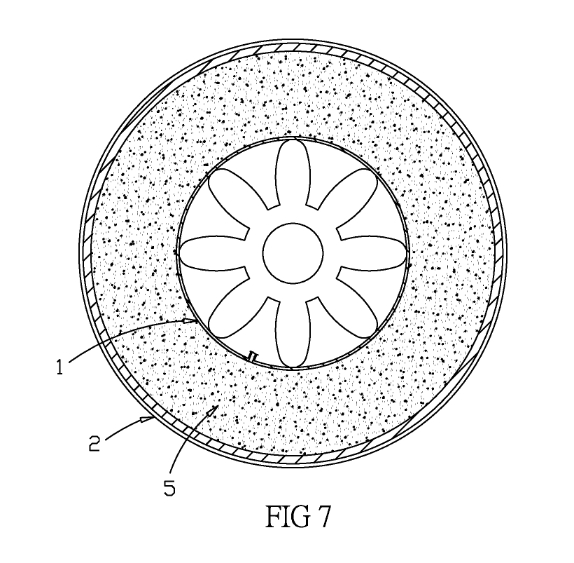

As shown in FIG. 2˜7, the manufacturing method of a foam filled wheel in the present invention comprises the following steps: a. as shown in FIG. 3, taking a steel ring 1 having a filling mouth 11, and a tire 2, set outside around the steel ring 1; b. as shown in FIG. 4, filling materials 5 of foaming materials are injected between the steel ring 1 and the tire 2 through the filling mouth 11 of the steel ring 1; c. as shown in FIG. 5, the filling materials 5 foam and flow into bottom of the tire 2 at the same time; d. as shown in FIG. 6, the tire 2 is filled with the filling materials 5 through the bottom of the tire 2, meanwhile gas in the inner tire 2 is discharged from the filling mouth 11 of the steel ring 1; e. covering the filling mouth check valve after destined time; f. as shown in FIG. 7, space between the steel ring 1 and the tire 2 is filled, after finishing foaming process of the filling materials 5; through the steps mentioned above, the tire will not leak, and it is achieved that the tire can support the car steadily even in case of damage.

As shown in FIG. 4, as processing the step b, firstly, setting the filling mouth 11 of the steel ring 1 upwards, then injecting the filling materials 5 of foaming materials between the steel ring 1 and the tire 2 through the filling mouth 11 of the steel ring 1, whereby it is easily to export gas in the inner tire thereafter.

As shown in FIG. 2, after the step 2 firstly processing: b1. after the filling materials 5 are disposed between the steel ring 1 and the tire 2 through the filling mouth 11 of the steel ring 1, injecting destined amount of gas, to avoid the filling materials 5 clogging the filling mouth 11 of the steel ring 1; then processing the step c.

As shown in FIG. 6A, the destined time of the step e is the same time, as the filling materials 5 process foaming into covering the filling mouth 11 of the steel ring 1. Therein, an operator can cover a filling mouth check valve (not shown), as filling materials 5 emerge at the filling mouth 11 of the steel ring 1.

As shown in FIG. 3A, outside around the steel ring 1 is further coated with release agent 13, whereby the finish foamed filling materials in the inner tire 2 cannot stick on the steel ring 1. Thence it is achieved, to change tires easily.

As shown in FIG. 2, after the step a processing firstly: a1. as shown in FIG. 3A, setting the filling mouth 11 of the steel ring 1 upwards and injecting release agent 13 through the filling mouth 11 of the steel ring 1, coating the steel ring outside around with the release agent 13, meanwhile, shaking the tire for increasing the coating area of release agent 13 outside the steel ring. Thereby in application of the present invention to a conventional air filled car wheel, costs for disassembling the tire are saved.

Therein, the release agent 13 is lipid or wax, which can avoid the filling materials 5 to stick on the steel ring.

1. A foam filled wheel, comprises:
a steel ring, connecting a power device of the car, wherein the steel ring has a filling mouth inside;
a tire, set outside around the steel ring; and
filling materials, disposed between the steel ring and the tire through a filling mouth;
it is characterized in that:
the filling materials are foam materials, injected between the steel ring and the tire through the filling mouth; whereby the tire will not leak, and the tire can support the car steadily even in case of damage.

2. The foam filled wheel of claim 1, wherein the tire has an inner body, where the filling materials are filled in the inner body.

3. The foam filled wheel of claim 1, wherein the filling materials comprise: foaming agents, antioxidants, foam stabilizers and catalysts.

4. The foam filled wheel of claim 3, wherein the foaming agents has 5˜18 weight % of the filling materials; the antioxidants 9˜25 weight %; the foam stabilizers 30˜60 weight %; and the catalysts 20˜25 weight %.

5. The foam filled wheel of claim 1, herein outside around the steel ring is coated with the release agent.

6. A manufacturing method of a foam filled wheel comprises the following steps:
a. taking a steel ring having a filling mouth, and a tire, set outside around the steel ring;
b. injecting filling materials of foaming materials, between the steel ring and tire through the filling mouth;
c. filling materials, foaming and flowing into the bottom of the tire at the same time;
d. filling materials filling the tire from the bottom, meanwhile gas in the inner tire is exported through the filling mouth;
e. covering a filling mouth check valve after a destined time;
f. filling the inner space between the ring steel and the tire after finishing the foaming process.

7. A manufacturing method of a foam filled wheel of the claim 6, wherein the tire has an inner tire body, filled with filling materials.

8. A manufacturing method of a foam filled wheel of the claim 6, wherein the filling materials comprises: foaming agents, antioxidants, foam stabilizers and catalysts.

9. A manufacturing method of a foam filled wheel of the claim 8, wherein the foaming agents has 5˜18 weight % of the filling materials; the antioxidants 9˜25 weight %; the foam stabilizers 30˜60 weight %; and the catalysts 20˜25 weight %.

10. A manufacturing method of a foam filled wheel of the claim 6, wherein after the step a processes: a1. setting the filling mouth of the steel ring upwards, and injecting release agent through the filling mouth of the steel ring, coating the steel ring outside around with the release agent; then processing the step b.

11. A manufacturing method of a foam filled wheel of the claim 6, wherein after the step b processes: b1. injecting destined amount of gas, after the filling materials injected between the steel ring and the tire through the filling mouth of the steel ring; then processing the step c.
